(19) United States
(12) Patent Application Publication
(10) Pub. No.: US 2009/0189512 A1
(43) Pub. Date: Jul. 30, 2009

(54) FLUORESCENCE EMITTING DEVICE

(76) Inventors: Akira Miyaguchi, Aichi (JP); Koichi Tamura, Aichi (JP)

Correspondence Address: MARTINE PENILLA & GENCARELLA, LLP, 710 LAKEWAY DRIVE, SUITE 200, SUNNYVALE, CA, 94085, US

(21) Appl. No.: 12/309,806

(22) PCT Filed: Apr. 27, 2007
(86) PCT No.: PCT/JP2007/059212

§ 371 Date: Jan. 30, 2009

(30) Foreign Application Priority Data
Aug. 2, 2006 (JP) 2006-210703

(51) Int. Cl. H01J 1/62

(52) U.S. Cl. 313/501

(57) ABSTRACT

[Object] To provide a light emitting device which can take out fluorescence with luminance higher than conventional by efficiently converting excitation light into fluorescence.

[Solution Means] A fluorescence emitting device includes an ultraviolet light source 2 which generates ultraviolet light to excite fluorescence by collision with a fluorescent material; a first optical thin-film layer 8 disposed on the front surface of the ultraviolet light source 2; a phosphor layer 6 containing the fluorescent material disposed on the front surface of the first optical thin-film layer 8; and a second optical thin-film layer 9 disposed on the front surface of the phosphor layer 6, wherein the first optical thin-film layer 8 transmits ultraviolet light and reflects fluorescence, and the second optical thin-film layer 9 reflects ultraviolet light and transmits fluorescence. Accordingly, excitation light can be efficiently converted into fluorescence, and deterioration of the luminescence efficiency can be suppressed, so that fluorescence with luminance higher than conventionally can be taken out.

### TECHNICAL FIELD

The present invention relates to a fluorescence emitting device which emits predetermined fluorescence by means of comparatively high-energy excitation light such as ultraviolet light and blue light.

### BACKGROUND ART

A light emitting device using phosphor for mainly obtaining white light for illumination is conventionally provided. This device irradiates a fluorescent material with comparatively high-energy light such as nonvisible light such as ultraviolet light or light which is blue light although it is visible as excitation light and takes out necessary white light. An example of such a light emitting device is shown in Patent document 1. According to the technique of Patent document 1, a display device phosphor including blue, green, and red luminescent components (fluorescent material) is irradiated with ultraviolet light from a light source to excite the blue, green, and red fluorescences, these are mixed in color, and white light is taken out.

According to the technique of Patent document 2, a blue light emitting diode is covered by a YAG phosphor, yellow or orange-yellow fluorescence is excited inside the YAG phosphor by using a part of blue light as excitation light and mixed with the blue light of the diode, and white light is taken out.

Patent document 1: Japanese Published Unexamined Patent Application No. 2000-73052

Patent document 2: Japanese Published Unexamined Patent Application No. 2005-216892

### DISCLOSURE OF THE INVENTION

### Problem to be Solved by the Invention

However, such conventional light emitting devices which take out white light by using fluorescence have several problems.

1) As in the case of Patent document 1, when fluorescence is emitted as visible light by using ultraviolet light as excitation light, in terms of fluorescence efficiency, preferably, as much ultraviolet light as possible collides with the fluorescent material of the phosphor. In other words, the greater the opportunity for ultraviolet light to encounter the fluorescent material, the higher the luminescence efficiency. However, to increase the opportunity for ultraviolet light to encounter the fluorescent material, the thickness of the phosphor must be increased or the concentration of the fluorescent material in the phosphor must be increased. However, if the phosphor is excessively thick or the fluorescent material concentration is high, conversely, photons of fluorescence scatter or are absorbed by the phosphor and the fluorescence is attenuated, so that eventually, ranges of the phosphor thickness and fluorescent material concentration for realizing optimum efficiency are determined. Therefore, sufficient improvement in luminescence efficiency cannot be realized by improving the phosphor itself, and a new means for improving the luminescence efficiency has been demanded.

2) In Patent document 2, a predetermined amount of yellow or orange-yellow fluorescence must be excited by using blue light from a blue light emitting diode, however, when a part of such blue light is used as excitation light, yellow or orange-yellow fluorescence may not be sufficiently taken out conventionally. Therefore, bluish white light is mixed. Therefore, the conversion efficiency of the excitation light into fluorescence is improved by increasing the thickness of the phosphor or setting a higher concentration of the fluorescent material. However, as a result, fluorescence and blue light are attenuated by the phosphor in the same manner as described above, and only white light with low luminance is obtained. In other words, the luminescence efficiency is inevitably sacrificed to improve the conversion efficiency.

From these problems, a light emitting device for taking out fluorescence with higher luminescence efficiency, in particular, white light whose application is widest by improving the conversion efficiency into fluorescence by using excitation light in the phosphor regardless of the thickness of the phosphor and the concentration of the fluorescent material, has been demanded.

The present invention was made in view of the problems in the conventional techniques. An object of the present invention is to provide a light emitting device which can take out fluorescence with luminance higher than in the conventional techniques by efficiently converting excitation light into fluorescence.

### Means for Solving the Problems

For solving the above-described problems, according to a first aspect of the invention, a fluorescence emitting device includes, at least, an excitation light generating source which generates excitation light for exciting fluorescence by collision with a fluorescent material; a first optical thin-film layer disposed on the front surface of the excitation light generating source; a fluorescence layer containing the fluorescent material disposed on the front surface of the first optical thin-film layer; and a second optical thin-film layer disposed on the front surface of the fluorescence layer, wherein the first optical thin-film layer transmits excitation light and reflects fluorescence, and the second optical thin-film layer reflects excitation light and transmits fluorescence.

In this configuration, excitation light emitted from the excitation light generating source is transmitted through the first optical thin-film layer and arrives at the fluorescence layer. The excitation light collides with the fluorescent material inside the fluorescence layer and excites the fluorescent material. The excitation light is absorbed by the fluorescent material, and based on the excitation light, the fluorescent material generates fluorescence. The generated fluorescence behaves as follows inside the fluorescence layer. First, fluorescence directed forward is radiated to the outside through the second optical thin-film layer. On the other hand, fluorescence directed backward (directed toward the excitation light generating source) collides with the first optical thin-film layer and is reflected and directed forward, and radiated to the outside through the second optical thin-film layer.

On the other hand, excitation light which did not encounter the fluorescent material passes through the fluorescence layer and collides with the second optical thin-film layer. The excitation light reflected there turns back and is given an opportunity to encounter the fluorescent material again during passing through the fluorescence layer, and if it collides with the fluorescent material, it excites the fluorescent material and generates fluorescence. The generated fluorescence behaves in the same manner as described above.

Therefore, in comparison with the conventional case having the fluorescence layer with the same thickness, the light path of excitation light is simply doubled in the present invention by providing the second optical thin-film layer. In other words, the possibility that the excitation light encounters fluorescent materials increases, and the conversion efficiency of the excitation light into fluorescence is improved. Further, by providing the first optical thin-film layer, fluorescence directed backward (directed toward the excitation light generating source) is reflected and directed forward, and the fluorescence amount to be used as illumination light is increased. Therefore, in comparison with the conventional light emitting device in total, fluorescence with high luminescence can be taken out.

The doubled light path of the excitation light realizes the conversion efficiency equivalent to that in the case where the fluorescence layer has the conventional thickness while the fluorescence layer is made thinner in thickness than in the conventional case. In this case, the thickness of the fluorescence layer is reduced, so that although there is no great difference in conversion efficiency from that of the conventional case, the thickness of the fluorescence layer becomes very thin, so that the attenuations of both excitation light and fluorescence in the fluorescence layer are significantly reduced, and as a result, in comparison with the conventional light emitting devices, higher-luminance fluorescence can be taken out.

Here, the fluorescence to be taken out is not especially limited to white light as long as it is obtained by excitation. “Excitation light generating source” is not especially limited as long as it can generate light capable of exciting fluorescence from the fluorescent material. Generally, use of an ultraviolet light source and a blue light source is assumed. In the following concept, violet light is regarded as near-ultraviolet light and included in ultraviolet light.

The optical thin-film layer selectively transmits and reflects light with a predetermined wavelength band, and as the optical thin film, generally, the optical thin-film has a multilayer film structure. Each component film layer of the multilayer is a dielectric material made of a metal oxide or a metal fluoride such as TiO₂ (titanium dioxide), Ta₂O₅ (tantalum pentoxide), ZrO₂ (zircon oxide), Al₂O₃ (aluminum oxide), Nb₂O₅ (niobium pentoxide), SiO₂ (silicon oxide), MgF₂ (magnesium fluoride), ZnO₂ (zinc oxide), HfO₂ (hafniumoxide), CaF₂ (calcium fluoride). The dielectric film of the present invention is preferably formed of an alternate layer in which at least two kinds of dielectric materials selected among these ten kinds are laminated so that a low refractive-index material and a high refractive-index material are laminated alternately in the light transmission direction. The number of component layers of the multilayer film is not especially limited. It is possible that the dielectric optical film can be formed by selecting and combining compounds for assuming reflective performance or transmissive performance for a desired wavelength. The deposition method of the optical thin-film layer has no special limited meaning, however, generally, the optical thin-film layer is preferably deposited by vapor deposition or sputtering.

According to a second aspect of the invention, in addition to the configuration of the first aspect of the invention, at a back face position of the excitation light generating source, a reflecting member which reflects excitation light reflected by the second optical thin-film layer and transmitted through the first optical thin-film layer in the same direction toward the first optical thin-film layer again is disposed.

In this configuration, in addition to the operation of the first aspect of the invention, excitation light which did not encounter the fluorescent material passes through the fluorescence layer and collides with the second optical thin-film layer, and is reflected and passes through the fluorescence layer again, and at this time, excitation light which did not collide with the fluorescent material in the fluorescence layer is transmitted through the first optical thin-film layer and collides with the reflecting member. Then, the excitation light which collided with the reflecting member is transmitted through the first optical thin-film layer again and passes through the fluorescence layer. Thus, the excitation light which does not collide with the fluorescent material reciprocates between the second optical thin-film layer and the reflecting member until it attenuates, and the opportunity for the excitation light to encounter the fluorescent material is increased.

According to a third aspect the invention, in addition to the configuration of the first or second aspect of the invention, excitation light to be generated from the excitation light generating source is ultraviolet light, and the fluorescence layer consists of a first fluorescence layer in which blue fluorescence is emitted disposed on the side closest to the excitation light generating source, a second fluorescence layer in which green fluorescence is emitted disposed outside the first fluorescence layer, and a third fluorescence layer in which red fluorescence is emitted disposed outside the second fluorescence layer, and between the first fluorescence layer and the second fluorescence layer, a third optical thin-film layer which transmits ultraviolet light and blue fluorescence and reflects green fluorescence is disposed, and between the second fluorescence layer and the third fluorescence layer, a fourth optical thin-film layer which transmits blue fluorescence and green fluorescence and reflects red fluorescence is disposed, and the second optical thin-film layer transmits all of blue, green, and red fluorescences.

In this configuration, ultraviolet light is transmitted through the first optical thin-film layer and collides with the fluorescent material in the first fluorescence layer, and excites this fluorescent material to emit blue fluorescence. Similarly, in the second fluorescence layer, green fluorescence is emitted, and in the third fluorescence layer, red fluorescence is emitted. At this time, blue fluorescence is transmitted through the first fluorescence layer, the third optical thin-film layer, the second fluorescence layer, the fourth optical thin-film layer, the third fluorescence layer, and the second optical thin-film layer in this order, and radiated. The green fluorescence is transmitted through the second fluorescence layer, the fourth optical thin-film layer, the third fluorescence layer, and the second optical thin-film layer in this order, and radiated. The red fluorescence is transmitted through the third fluorescence layer and the second optical thin-film layer in this order, and radiated. Accordingly, the three colors are mixed to generate white light.

On the other hand, the fluorescences may be directed backward (directed toward the excitation light generating source). In this case, blue fluorescence collides with the first optical thin-film layer and is reflected and turned forward. The blue fluorescence turned forward is emitted to the outside as described above. Similarly, the green fluorescence collides with the third optical thin-film layer and is reflected and turned forward and emitted to the outside. Further, the red fluorescence collides with the fourth optical thin-film layer and is reflected and turned forward and emitted to the outside.

On the other hand, excitation light which does not encounter the fluorescent material is transmitted through the first fluorescence layer, the third optical thin-film layer, the second fluorescence layer, the fourth optical thin-film layer, and the third fluorescence layer in this order, and collides with the second optical thin-film layer. The excitation light reflected here turns back and is given an opportunity to encounter the fluorescent materials again during passing through the fluorescence layers. Then, when the excitation light collides with the fluorescent materials in the fluorescence layers, it excites the fluorescent materials to generate fluorescences. Fluorescences generated in the fluorescence layers are reflected and radiated to the outside by the first, third, and fourth optical thin-film layers without being directed inward.

In this configuration, as described in paragraph 0005 above, the thickness of the fluorescence layer can be reduced, so that when fluorescence in a lower fluorescence layer (closer to the excitation light source side) passes through an upper fluorescence layer, attenuations of both excitation light and fluorescence caused by absorption and scattering are reduced, so that in such a three-primary-color multistage structure, the improvement effect significantly increases. The proportions of the fluorescences in the respective colors can be controlled by not only the phosphor components and layer thicknesses, but also the transmissivity and reflectance of the dielectric layer.

According to a fourth aspect of the invention, in addition to the configuration of the first or second aspect of the invention, excitation light generated from the excitation light generating source is ultraviolet light, and the fluorescence layer consists of a first fluorescence layer disposed on the excitation light generating source side in which fluorescence with a predetermined wavelength band having components on the longer wavelength side than the wavelength of blue as a peak of luminance less than components on the shorter wavelength side (hereinafter, color with such a wavelength band is defined as blue) is emitted, and a second fluorescence layer disposed outside the first fluorescence layer in which fluorescence with a predetermined wavelength band having components on the shorter wavelength side than the wavelength of yellow as a peak of luminance less than components on the longer wavelength side (hereinafter, color with such a wavelength band is defined as yellow) is emitted, and between the first fluorescence layer and the second fluorescence layer, a third optical thin-film layer which transmits ultraviolet light and blue fluorescence and reflects yellow fluorescence is disposed.

In this configuration, ultraviolet light is transmitted through the first optical thin-film layer, collides with the fluorescent material in the first fluorescence layer, and excites the fluorescent material to emit blue fluorescence. Similarly, yellow fluorescence is emitted in the second fluorescence layer. At this time, the blue fluorescence is transmitted through the first fluorescence layer, the third optical thin-film layer, the second fluorescence layer, and the second optical thin-film layer in this order and radiated. The yellow fluorescence is transmitted through the second fluorescence layer and the second optical thin-film layer and radiated. Accordingly, these two colors are mixed to generate white light.

On the other hand, when fluorescences are directed backward (directed toward the excitation light generating source), blue fluorescence collides with the first optical thin-film layer and is reflected and turned forward. This blue fluorescence turned forward is emitted to the outside as described above. The yellow fluorescence collides with the third optical thin-film layer and is reflected and turned forward. This yellow fluorescence turned forward is emitted to the outside as described above.

On the other hand, excitation light which does not encounter the fluorescent material is transmitted through the first fluorescence layer, the third optical thin-film layer, and the second fluorescence layer in this order, and then collides with the second optical thin-film layer. The excitation light reflected here is given an opportunity to encounter the fluorescent materials again during passing through the fluorescence layers. Then, when the excitation light collides with the fluorescent materials in the fluorescence layers, it excites the fluorescent materials to generate fluorescences. Fluorescences generated in the respective fluorescence layers are reflected and radiated to the outside by the first and third optical thin-film layer without being directed inward.

In the description above, as definition of blue, blue which is not greenish is included, and as a definition of yellow, yellow which is reddish is included, and these are for emission of fluorescence as close to pure white as possible when blue and yellow are mixed.

According to a fifth aspect of the invention, in addition to the configuration of the first or second aspect of the invention, excitation light generated from the excitation light generating source is blue light, and the fluorescence layer emits fluorescence with a predetermined wavelength band including yellow as a peak of luminance, and the second optical thin-film layer transmits a part of the excitation light.

In this configuration, blue light is transmitted through the first optical thin-film layer, and collides with the fluorescent materials in the fluorescence layer and excites the fluorescent material to emit fluorescence with a predetermined wavelength band including yellow as a peak of luminance (hereinafter, in this section, color with such a wavelength band is defined as yellow). All of blue light is not excitation light, but a part of blue light is not absorbed by the fluorescent material, and is transmitted through the second optical thin-film layer and radiated to the outside. Accordingly, these two colors are mixed to generate white light.

Further, blue light which neither excited the fluorescent material nor was transmitted through the second optical thin-film layer collides with the second optical thin-film layer and is reflected and turned, and is given an opportunity to encounter the fluorescent materials again in the middle of passing through the fluorescence layers. Accordingly, the opportunity for yellow fluorescence to be emitted is increased. In other words, in some conventional cases where a part of blue light is used as excitation light, yellow or orange-yellow light cannot be sufficiently taken out, however, in this aspect of the invention, even without processing such as increasing the thickness of the phosphor or concentration of the fluorescent material which leads to deterioration of luminescence efficiency, yellow or orange-yellow fluorescence can be increased, and as a result, white light with high luminance can be obtained.

“Fluorescence with a predetermined wavelength band including yellow as a peak of luminance” means not only emission of yellow fluorescence but also emission of fluorescence turning yellow by mixing fluoroescences whose wavelengths are shifted to the red side and the blue side across yellow.

### EFFECT OF THE INVENTION

According to the aspect of the invention described above, excitation light can be efficiently converted into fluorescence, and deterioration of luminescence efficiency can be suppressed, so that fluorescence with luminance higher than conventionally can be taken out.

### BEST MODE FOR CARRYING OUT THE INVENTION

Hereinafter, detailed examples will be described with reference to the drawings.

### Example 1

FIG. 1 is a schematic explanatory view of a fluorescence emitting device 1 of Example 1 of the present invention. The fluorescence emitting device 1 includes an ultraviolet light source 2 as an excitation light generating source. The ultraviolet light source 2 is a luminescence source which outputs ultraviolet light, and radiates ultraviolet light to the entire circumference of the luminescence source. As the ultraviolet light source 2, for example, use of an ultraviolet light emitting diode, an ultraviolet laser diode, or a fluorescent tube, etc., is assumed. Behind the ultraviolet light source 2, a reflecting mirror 3 curved into a semicircular shape is disposed. In front of the ultraviolet light source 2, a phosphor unit 5 is disposed. As shown in FIG. 2, the phosphor unit 5 includes a phosphor layer 6 containing RGB (red, green, and blue) fluorescent materials. The phosphor layer 6 generates red, green, and blue fluorescences by using an ultraviolet ray as excitation light. These fluorescent colors are mixed to generate white light.

Outside (opposite side of the ultraviolet light source 2) the phosphor layer 6, a transparent substrate 7 is disposed. On the inner surface of the phosphor layer 6, a first optical thin-film layer 8 is formed, and on the outer surface of the substrate 7, a second optical thin-film layer 9 is formed. FIG. 2 is drawn for understandably describing the configuration and operation of the phosphor unit 5, so that thicknesses, etc., of the layers are illustrated without relation to actual ratios.

The first optical thin-film layer 8 is set to have a reflectance of 98% on average (transmissivity not more than 5% on average) with respect to light of 400 to 800 nanometers, and is set to have a reflectance not more than 5% on average (transmissivity of 98% on average) with respect to light of 250 to 320 nanometers. In other words, the first optical thin-film layer 8 has an extremely high reflectance with respect to visible light (from red to blue), and an extremely low reflectance with respect to ultraviolet light.

On the other hand, the second optical thin-film layer 9 is set to have a reflectance not more than 5% on average (transmissivity of 98% on average) with respect to light of 400 to 800 nanometers, and set to have a reflectance of 98% on average (transmissivity not more than 5% on average) with respect to light of 250 to 320 nanometers. In other words, the second optical thin-film layer 9 has an extremely low transmissivity with respect to ultraviolet light, and has an extremely high transmissivity with respect to visible light (from red to blue). An example of characteristics of the first optical thin-film layer 8 is shown in Table 1, and an example of characteristics of the second optical thin-film layer 9 is shown in Table 2.

In this configuration, fluorescence is emitted by the following operation.

As shown in FIG. 2, ultraviolet light radiated toward the phosphor unit 5 from the ultraviolet light source 2 in the loci A to C is transmitted through the first optical thin-film layer 8 and enters the inside of the phosphor layer 6. Ultraviolet light radiated to the back or side of the ultraviolet light source 2 is reflected by the reflecting mirror 3 and is also transmitted through the first optical thin-film layer and enters the inside of the phosphor layer 6.

When the ultraviolet light encounters the RGB fluorescent materials like the locus A, it excites the RGB fluorescent materials to generate fluorescence. Fluorescence directed forward of the generated fluorescence is transmitted through the second optical thin-film layer 9 and radiated to the outside like the locus Aa. On the other hand, fluorescence directed backward (toward the ultraviolet light source 2) collides with the first optical thin-film layer 8 and is turned forward, and transmitted through the second optical thin-film layer 9 and radiated to the outside like the locus Ab.

On the other hand, when ultraviolet light which could not excite the RGB fluorescent materials reaches the second optical thin-film layer 9, it is reflected and turned toward the ultraviolet light source 2 like the locus B. Accordingly, an opportunity for this to encounter the RGB fluorescent materials increases. Further, the ultraviolet light which did not encounter the RGB fluorescent materials even after being turned is transmitted through the first optical thin-film layer 8, reflected by the reflecting mirror 3, transmitted through the first optical thin-film layer 8, and enters the inside of the phosphor layer 6 like the locus C.

This configuration provides the following effects in Example 1.

(1) Ultraviolet light which was radiated from the ultraviolet light source 2 and entered the inside of the phosphor unit 5 is reflected by the second optical thin-film layer 9 without being emitted to the outside, so that the opportunity to encounter the RGB fluorescent materials increases, and the conversion efficiency of the ultraviolet light into fluorescence is improved.
(2) Fluorescence which was not directed forward is reflected by the first optical thin-film layer 8 and directed forward, so that an increase in light amount can be expected and the luminance increases.
(3) The ultraviolet light which was turned and reflected from the first optical thin-film layer 2 side toward the ultraviolet light source 8 is reflected by the reflecting mirror 3 and transmitted through the first optical thin-film layer 8 again and enters the inside of the phosphor layer 6, so that the opportunity to encounter the fluorescent material increases, and the conversion efficiency of ultraviolet light into fluorescence is further improved.

### Example 2

According to Example 2, the configuration of the phosphor layer 6 of Example 1 is divided into three fluorescent portions containing a B (blue) fluorescent material, a G (green) fluorescent material, and an R (red) fluorescent material, respectively. Hereinafter, differences from Example 1 will be mainly described.

As shown in FIG. 3, in the phosphor unit 11, in order from the ultraviolet light source 2 side, a transparent substrate 12 as a substrate, a first phosphor layer 13, a second phosphor layer 14, and a third phosphor layer 15 are arranged. The first phosphor layer contains a B (blue) fluorescent material, and generates blue fluorescence by using an ultraviolet ray as excitation light. The second phosphor layer 14 contains a G (green) fluorescent material, and generates green fluorescence by using an ultraviolet ray as excitation light. The third phosphor layer 15 contains an R (red) fluorescent material, and generates red fluorescence by using an ultraviolet ray as excitation light. These fluorescent colors are mixed to generate white light.

On the inner surface of the substrate 12, the same optical thin-film layer 8 as in Example 1 is formed, and on the outer surface of the third phosphor layer 15 as the outermost layer, the same second optical thin-film layer 9 as in Example 1 is formed. Between the surfaces of the first phosphor layer 13 and the second phosphor layer 14, a third optical thin-film layer 16 is disposed, and between the surfaces of the second phosphor layer 14 and the third phosphor layer 15, a fourth optical thin-film layer 17 is disposed. FIG. 3 is drawn for understandably describing the configuration and operation of the phosphor unit 11, so that the thicknesses, etc., of the layers are illustrated without relation to actual ratios.

The third optical thin-film layer 16 is set to have a reflectance of 98% on average (transmissivity not more than 5% on average) with respect to light of 450 to 800 nanometers, and set to have a reflectance not more than 5% on average (transmissivity of 98% on average) with respect to light of 250 to 400 nanometers. In other words, the third optical thin-film layer 16 has an extremely low transmissivity with respect to a wavelength not less than the wavelength of green light, and an extremely high transmissivity with respect to light from ultraviolet to blue.

The fourth optical thin-film layer 17 is set to have a reflectance not less than 95% on average (transmissivity not more than 5% on average) with respect to light of 580 to 800 nanometers, and set to have a reflectance not more than 5% on average (transmissivity not less than 95% on average) with respect to light of 250 to 520 nanometers. In other words, the fourth optical thin-film layer has an extremely low transmissivity with respect to a wavelength not less than the wavelength of red light, and an extremely high transmissivity with respect to light from ultraviolet to green. An example of characteristics of the third optical thin-film layer 16 is shown in Table 3, and an example of characteristics of the fourth optical thin-film layer 17 is shown in Table 4.

In this configuration, fluorescence is emitted by the following operation.

As shown in FIG. 3, like the locus A of radiation from the ultraviolet light source 2 toward the phosphor unit 5, ultraviolet light is transmitted through the first optical thin-film layer 8 and enters the inside of the first phosphor layer 13 first. Here, when a part of the ultraviolet light encounters the B fluorescent material, it excites this material to generate blue fluorescence. Similarly, green fluorescence and red fluorescence are generated in the second phosphor layer 14 and the third phosphor layer 15, respectively. Fluorescence directed forward of the generated fluorescences is transmitted through the more outside optical thin-film layers and phosphor layers and radiated to the outside like the loci Aa.

On the other hand, in fluorescence directed backward (toward the ultraviolet light source 2), like the loci Ab, blue light collides with the first optical thin-film layer 8 and is reflected, green light collides with the third optical thin-film layer 16 and is reflected, and red light collides with the fourth optical thin film layer 17 and is reflected, and accordingly, these are directed forward, transmitted through the second optical thin film layer 9, and radiated to the outside.

On the other hand, when ultraviolet light which could not excite the fluorescent materials of the phosphor layers 13 to 15 reaches the second optical thin-film layer 9, it is reflected and turned toward the ultraviolet light source 2 like the locus B. Accordingly, the opportunity to encounter the fluorescent materials increases.

Further, ultraviolet light which did not encounter the fluorescent materials even after being turned is transmitted through the first optical thin-film layer 8, reflected again by the reflecting mirror 3 and transmitted through the first optical thin-film layer 8 again, and enters the inside of the phosphor layer 6 like the locus C.

This configuration provides the following effects in Example 2.

(1) Ultraviolet light which was radiated from the ultraviolet light source 2 and entered the inside of the phosphor unit 11 is reflected by the second optical thin-film layer 9 without being emitted to the outside, so that the opportunity to encounter the fluorescent materials of the phosphor layers 13 to 15 increases, and the conversion efficiency of ultraviolet light into fluorescence is improved.
(2) Fluorescences which were not directed forward are reflected by the first optical thin-film layer 8, the third optical thin-film layer 16, and the fourth optical thin-film layer 17, and directed forward, so that an increase in light amount can be expected and the luminance increases.
(3) Ultraviolet light which was turned and reflected from the first optical thin-film layer 8 toward the ultraviolet light source 2 side is reflected by the reflecting mirror 3 and transmitted through the first optical thin-film layer 8 and enters the phosphor layers 13 to 15 again, so that the opportunity to encounter the fluorescent materials increases, and the conversion efficiency of ultraviolet light into fluorescence is improved.
(4) The phosphor layers 13 to 15 are divided into blue, green, and red so that the conversion efficiency into fluorescence can be adjusted in each of the phosphor layers 13 to 15, and color rendering performance when colors are mixed can be increased.

### Example 3

According to Example 3, the configuration of the phosphor layer 6 of Example 1 is divided into two fluorescent portions containing a B (blue) fluorescent material and a Y (yellow) fluorescent material, respectively. Hereinafter, differences from Example 1 will be mainly described.

As shown in FIG. 4, in the phosphor unit 21, in order from the ultraviolet light source 2 side, a transparent substrate 22 as a substrate, a first phosphor layer 23, and a second phosphor layer 24 are arranged. The first phosphor layer 23 contains aB (blue) fluorescent material, and generates blue fluorescence by using an ultraviolet ray as excitation light. The second phosphor layer 14 contains a Y (yellow) fluorescent material, and generates yellow fluorescence by using an ultraviolet ray as excitation light. These fluorescent colors are mixed to generate white light.

The phosphor layer can be formed by a known method such as coating, calcination, and dispersion into a base material, and here, coating is used as an example.

On the inner surface of the substrate 22, the same first optical thin-film layer 8 as in Example 1 is formed, and on the outer surface of the second phosphor layer 24 as the outermost layer, the same second optical thin-film layer 9 as in Example 1 is formed. Between the surfaces of the first phosphor layer 23 and the second phosphor layer 24, a third optical thin-film layer 26 is disposed. FIG. 4 is drawn for understandably describing the configuration and operation of the phosphor unit 21, so that the thicknesses, etc., of the layers are illustrated without relation to actual ratios.

The third optical thin-film layer 26 is set to have a reflectance not less than 95% on average (transmissivity not more than 5% on average) with respect to light of 520 to 800 nanometers, and set to have a reflectance not less than 5% on average (transmissivity not less than 95% on average) with respect to light of 300 to 450 nanometers. In other words, the third optical thin-film layer has an extremely low transmissivity with respect to a wavelength not less than that of yellow light, and an extremely high transmissivity with respect to light from ultraviolet to blue. An example of characteristics of the third optical thin-film layer 26 is shown in Table 5.

In this configuration, fluorescence is emitted by the following operation.

As shown in FIG. 4, ultraviolet light radiated toward the phosphor unit 5 from the ultraviolet light source 2 is transmitted through the first optical thin-film layer 8 and enters the inside of the first phosphor layer 23 first. Here, a part of the ultraviolet light encounters the B fluorescent material and excites this to generate blue fluorescence (locus A). Similarly, yellow fluorescence is generated in the second phosphor layer 24 (locus A). Fluorescence directed forward of the generated fluorescence is transmitted through the optical thin-film layers and phosphor layers further outside than the fluorescence and radiated to the outside like the loci Aa.

On the other hand, blue light of fluorescence directed backward (toward ultraviolet light source 2) collides with the first optical thin-film layer 8 and is reflected, and yellow light collides with the third optical thin-film layer 26 and is reflected and turned forward, and transmitted through the second optical thin-film layer 9 and radiated to the outside (loci Ab).

On the other hand, ultraviolet light which could not excite the fluorescent materials of the phosphor layers 23 and 24 reaches the second optical thin-film layer 9 and is turned toward the ultraviolet light source 2 like the locus B. Accordingly, the opportunity to encounter the fluorescent materials increases. Further, ultraviolet light which did not encounter the fluorescent materials even after it was turned as described above is transmitted through the first optical thin-film layer 8 and reflected by the reflecting mirror 3 again, transmitted through the first optical thin-film layer, and enters the inside of the phosphor layer 23 like the locus C.

This configuration provides the following effect in Example 3.

(1) Ultraviolet light which was radiated from the ultraviolet light source 2 and entered the inside of the phosphor unit 21 is reflected by the second optical thin-film layer 9 without being emitted to the outside, so that the opportunity to encounter the fluorescent materials of the phosphor layers 23 and 24 increases, and the conversion efficiency of ultraviolet light into fluorescence is improved.
(2) Fluorescences which were not directed forward are reflected by the first optical thin-film layer 8 and the third optical thin-film layer 26 and directed forward, so that an increase in light amount can be expected and the luminance increases.
(3) Ultraviolet light which was turned and reflected from the first optical thin-film layer 8 toward the ultraviolet light source 2 side is reflected by the reflecting mirror 3 and transmitted through the first optical thin-film layer 8 again and enters the insides of the phosphor layers 23 and 24, so that the opportunity to encounter the fluorescent materials increases, and the conversion efficiency of ultraviolet light into fluorescence is further improved.
(4) The phosphor layers 23 and 24 are divided into blue and yellow, so that the conversion efficiency into fluorescence can be adjusted in each of the phosphor layers 23 and 24, and color rendering performance when colors are mixed can be increased.

### Example 4

FIG. 5 shows a mold-type white LED device 31 in which a fluorescence emitting device 30 of Example 4 of the present invention is installed. The white LED device 31 assumes a main body 32 which is molded from a transparent epoxy resin and has a cannonball-shaped appearance. In the main body 32, tip end sides of a p-side electrode lead 35a and n-side electrode lead 35b are enclosed. The p-side electrode lead 35a is connected to a lead frame 37 enclosed in the main body 32. The tip end of the n-side electrode lead 35b is disposed near the center of the internal space S, and to the tip end of this lead 35b, a reflecting mirror 38 formed into an inverted cone shape is fixed. Inside the reflecting mirror 38, the fluorescence emitting device 30 shown in FIG. 2 is disposed. A wire 34 made of a golden wire is bonded to an LED chip 36 as an excitation light generating source from the lead frame 17.

Next, the fluorescence emitting device 30 of the white LED device 31 will be described. As shown in FIG. 6, a stand 37 maintaining a conduction state with the n-side electrode lead 35b is stood inside the reflecting mirror 38, and to the upper portion of the stand 37, an LED chip 36 as a blue light emitting diode is fixed by silver solder. To the opening face 38a of the reflecting mirror 38, a phosphor unit 40 is fitted so as to cover the opening face 38a. The LED chip 36, the phosphor unit 40, and the reflecting mirror 38 compose the fluorescence emitting device 30. The incidence and exit medium of the optical thin-film layer to be applied to this Example 4 is not air but a mold material (transparent epoxy resin), so that optimization design is made so as to obtain desired optical performance by considering the refractive index of the mold material.

As shown in FIG. 7, the phosphor unit 40 includes a phosphor layer 41 containing a (yellow) fluorescent material. The phosphor layer 41 generates yellow fluorescence by using an ultraviolet ray as excitation light. This yellow fluorescence and blue light of the blue light emitting diode are mixed to generate white light.

Outside the phosphor layer 41, a transparent substrate 42 is disposed as a substrate. On the inner surface of the phosphor layer 41, a first optical thin-film layer 43 is formed, and on the outer surface of the substrate 42, a second optical thin-film layer 44 is formed. FIG. 7 is drawn for understandably describing the configuration and operation of the phosphor unit 5, so that the thicknesses, etc., of the layers are illustrated without relation to actual ratios.

The first optical thin-film layer 43 is set so as to have a reflectance not less than 98% on average (transmissivity not more than 5% on average) with respect to light of 450 to 800 nanometers, and set so as to have a reflectance not more than 5% on average (transmissivity not less than 95% on average) with respect to light of 300 to 400 nanometers. In other words, the transmissivity with respect to yellow light is set to be extremely low, and is set to be extremely high with respect to blue light.

On the other hand, the second optical thin-film layer 44 is set so as to have a reflectance not more than 5% on average (transmissivity not less than 95% on average) with respect to light of 450 to 800 nanometers, and set so as to have a reflectance of 48% on average with respect to light of 300 to 400 nanometers. In other words, in this Example 4, the transmissivity with respect to blue light is set to be approximately half the light amount of blue light reaching the second optical thin-film layer 44, and on the other hand, the transmissivity with respect to yellow light is set to be extremely high. An example of characteristics of the first optical thin-film layer 43 is shown in Table 6, and an example of characteristics of the second optical thin-film layer 44 is shown in Table 7.

In this configuration, fluorescence is emitted by the following operation.

As shown in FIG. 7, blue light radiated toward the phosphor unit 40 from the LED chip 36 is transmitted through the first optical thin-film layer 8 and enters the first phosphor layer 41 first like the locus A. Here, apart of the blue light encounters the Y fluorescent material and excites this to generate yellow fluorescence. Fluorescence directed forward of the generated yellow fluorescence is transmitted through the second optical thin-film layer 44 and radiated to the outside like the locus Aa. On the other hand, yellow fluorescence directed backward (toward the LED chip 36) collides with the first optical thin-film layer 8 and is turned forward like the locus Ab, and transmitted through the second optical thin-film layer 44 and radiated to the outside.

On the other hand, blue light which did not encounter the Y fluorescent material reaches the second optical thin-film layer 9 and a part of this is reflected and turned toward the LED chip 36 like the locus B. Accordingly, the opportunity to encounter the Y fluorescent material increases. Further, ultraviolet light which did not encounter fluorescent materials even after being turned as described above is transmitted through the first optical thin-film layer 43, reflected by the reflecting mirror 38, and transmitted through the first optical thin-film layer 43 again and enters the inside of the phosphor layer 41 like the locus C.

A part of the blue light which did not encounter the Y fluorescent material is transmitted through the second optical thin-film layer 9 and radiated to the outside. In this Example 5, approximately half of the light amount reaching the second optical thin-film layer 44 is radiated to the outside.

This configuration provides the following effects in Example 4.

(1) Blue light which was radiated from the LED chip 36 and entered the inside of the phosphor unit 40 is reflected by the second optical thin-film layer 9 without being emitted to the outside, so that the opportunity to encounter the Y fluorescent material of the phosphor layer 41 increases, and the conversion efficiency of yellow light into fluorescence is improved.
(2) Yellow fluorescence which was not directed forward is reflected by the first optical thin-film layer 43 and directed forward, so that an increase in light amount can be expected and the luminance increases. In addition, the ratio of yellow light to blue light to be radiated to the outside is increased.
(3) Blue light which was turned and reflected from the first optical thin-film layer 43 toward the LED chip 36 side is reflected by the reflecting mirror 3 and transmitted through the first optical thin-film layer 43 again and enters the inside of the phosphor layer 41, so that the conversion efficiency of the blue light into yellow fluorescence is improved.

The present invention can be changed and embodied as follows.

In the examples above, an example of application to a mold-type white LED device 31 is described, however, application to a chip-type LED device is also allowed.

Phosphor units 11 and 21 may be configured by using combinations and lamination orders other than those of Example 2 and Example 3.

In the examples above, the phosphor layers 6 and 23 are formed by means of vapor deposition or coating, etc., on the substrate 7, and other than the phosphor layers 6 and 23, a phosphor layer formed by containing a fluorescent material in a material such as an acrylic plate may be provided.

Besides, the present invention can be freely carried out without departing from the gist of the present invention.

### BRIEF DESCRIPTION OF THE DRAWINGS

FIG. 1 is a schematic explanatory view of a fluorescence emitting device of Example 1 of the present invention;

FIG. 2 is a schematic explanatory view for describing locus patterns of excitation light and fluorescence in Example 1;

FIG. 3 is a schematic explanatory view for describing locus patterns of excitation light and fluorescence in Example 2;

FIG. 4 is a schematic explanatory view for describing locus patterns of excitation light and fluorescence in Example 3;

FIG. 5 is as front view of an LED chip of Example 4;

FIG. 6 is an essential portion sectional view of the LED chip of Example 4; and

FIG. 7 is a schematic explanatory view for describing locus patterns of excitation light and fluorescence in Example 4.

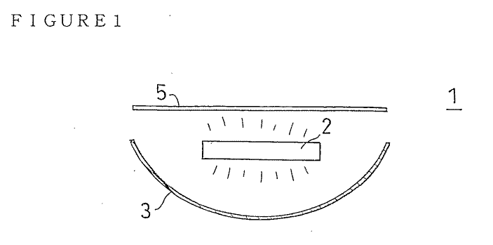

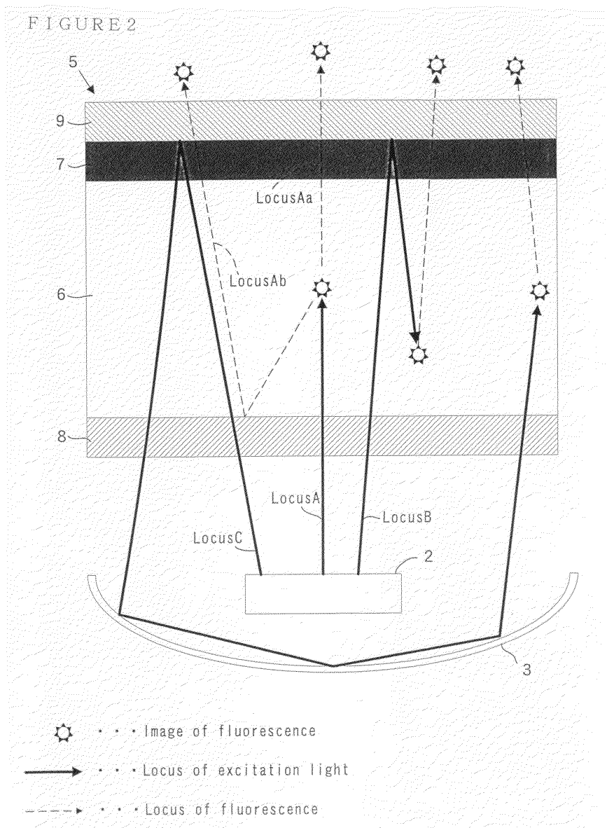

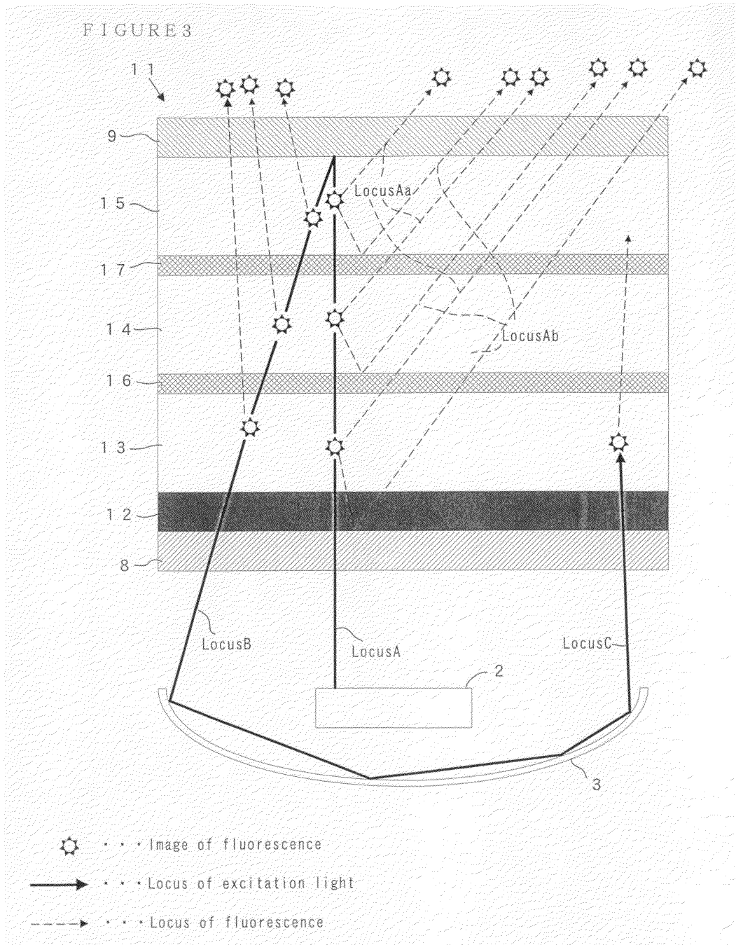

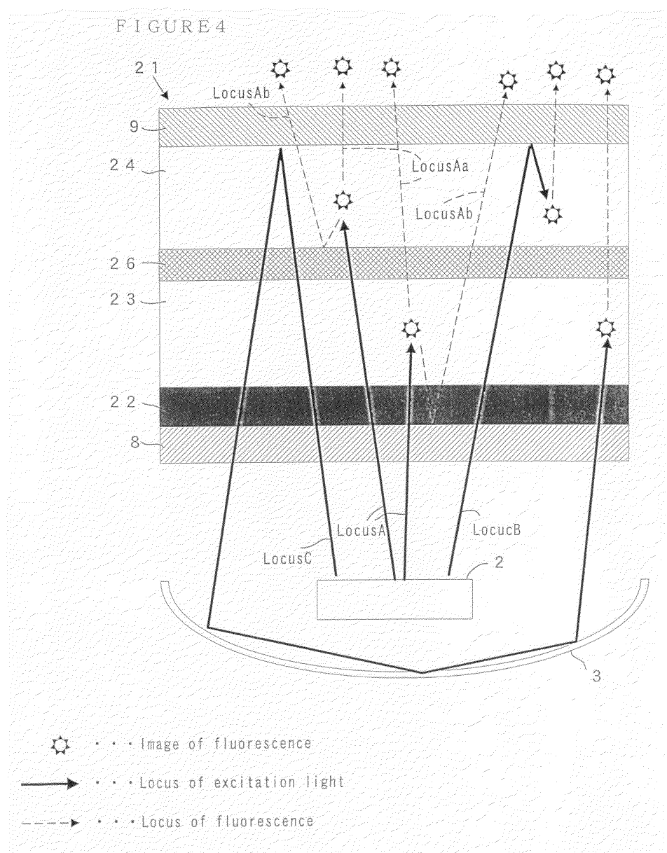

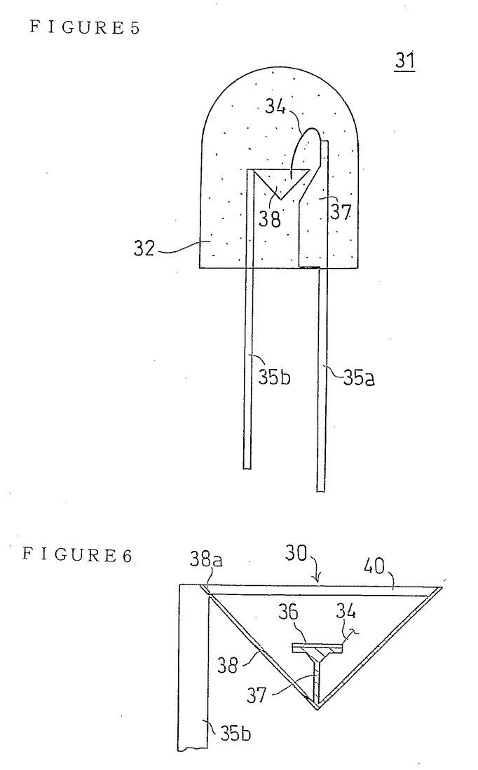

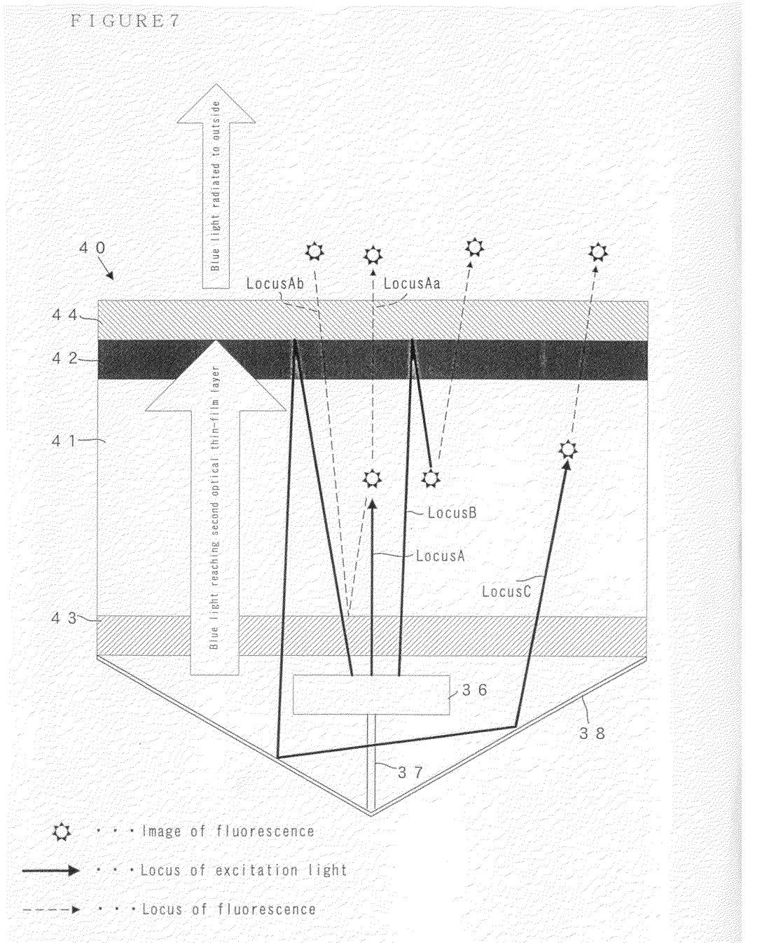

### DESCRIPTION OF THE REFERENCE NUMERALS

1, 30: Fluorescence emitting device, 2: Ultraviolet light source as excitation light generating source, 3, 38: Reflecting mirror as reflecting member, 6: Phosphor layer as fluorescence layer, 13, 23: First phosphor layer as fluorescence layer, 14, 24: Second phosphor layer as fluorescence layer, 15: Third phosphor layer as fluorescence layer, 6: Phosphor layer as fluorescence layer, 8, 43: First optical thin-film layer, 9, 44: Second optical thin-film layer, 16, 26: Third optical thin-film layer, 17: Fourth optical thin-film layer, 36: LED chip as excitation light source

1. A fluorescence emitting device including at least:
an excitation light generating source which generates excitation light for exciting fluorescence by collision with a fluorescent material;
a first optical thin-film layer disposed on the front surface of the excitation light generating source;
a fluorescence layer containing the fluorescent material disposed on the front surface of the first optical thin-film layer; and
a second optical thin-film layer disposed on the front surface of the fluorescence layer, wherein
the first optical thin-film layer transmits excitation light and reflects fluorescence, and
the second optical thin-film layer reflects excitation light and transmits fluorescence.

2. The fluorescence emitting device according to claim 1, wherein
at a back face position of the excitation light generating source, a reflecting member which reflects excitation light reflected by the second optical thin-film layer and transmitted through the first optical thin-film layer in the same direction toward the first optical thin-film layer again is disposed.

3. The fluorescence emitting device according to claim 1, wherein
excitation light to be generated from the excitation light generating source is ultraviolet light, and the fluorescence layer consists of a first fluorescence layer in which blue fluorescence is emitted disposed on the side closest to the excitation light generating source, a second fluorescence layer in which green fluorescence is emitted disposed outside the first fluorescence layer, and a third fluorescence layer in which red fluorescence is emitted disposed outside the second fluorescence layer, and between the first fluorescence layer and the second fluorescence layer, a third optical thin-film layer which transmits ultraviolet light and blue fluorescence and reflects green fluorescence is disposed, and between the second fluorescence layer and the third fluorescence layer, a fourth optical thin-film layer which transmits ultraviolet light, blue fluorescence, and green fluorescence and reflects red fluorescence is disposed, and the second optical thin-film layer transmits all blue, green, and red fluorescences.

4. The fluorescence emitting device according to claim 2, wherein
excitation light to be generated from the excitation light generating source is ultraviolet light, and the fluorescence layer consists of a first fluorescence layer in which blue fluorescence is emitted disposed on the side closest to the excitation light generating source, a second fluorescence layer in which green fluorescence is emitted disposed outside the first fluorescence layer, and a third fluorescence layer in which red fluorescence is emitted disposed outside the second fluorescence layer, and between the first fluorescence layer and the second fluorescence layer, a third optical thin-film layer which transmits ultraviolet light and blue fluorescence and reflects green fluorescence is disposed, and between the second fluorescence layer and the third fluorescence layer, a fourth optical thin-film layer which transmits ultraviolet light, blue fluorescence, and green fluorescence and reflects red fluorescence is disposed, and the second optical thin-film layer transmits all blue, green and red fluorescences.

5. The fluorescence emitting device according to claim 1, wherein
excitation light generated from the excitation light generating source is ultraviolet light, and the fluorescence layer consists of a first fluorescence layer disposed on the excitation light generating source side in which fluorescence with a predetermined wavelength band having components on the longer wavelength side than the wavelength of blue as a peak of luminance less than components on the shorter wavelength side is emitted, and a second fluorescence layer disposed outside the first fluorescence layer in which fluorescence with a predetermined wavelength band having components on the shorter wavelength side than the wavelength of yellow as a peak of luminance less than components on the longer wavelength side is emitted, and between the first fluorescence layer and the second fluorescence layer, a third optical thin-film layer which transmits ultraviolet light and blue fluorescence and reflects yellow fluorescence is disposed.

6. The fluorescence emitting device according to claim 2, wherein
excitation light generated from the excitation light generating source is ultraviolet light, and the fluorescence layer consists of a first fluorescence layer disposed on the excitation light generating source side in which fluorescence with a predetermined wavelength band having components on the longer wavelength side than the wavelength of blue as a peak of luminance less than components on the shorter wavelength side is emitted, and a second fluorescence layer disposed outside the first fluorescence layer in which fluorescence with a predetermined wavelength band having components on the shorter wavelength side than the wavelength of yellow as a peak of luminance less than components on the longer wavelength side is emitted, and between the first fluorescence layer and the second fluorescence layer, a third optical thin-film layer which transmits ultraviolet light and blue fluorescence and reflects yellow fluorescence is disposed.

7. The fluorescence emitting device according to claim 1, wherein excitation light generated from the excitation light generating source is blue light, and the fluorescence layer emits fluorescence with a predetermined wavelength band including yellow as a peak of luminance, and the second optical thin-film layer transmits a part of the excitation light.

8. The fluorescence emitting device according to claim 2, wherein excitation light generated from the excitation light generating source is blue light, and the fluorescence layer emits fluorescence with a predetermined wavelength band including yellow as a peak of luminance, and the second optical thin-film layer transmits a part of the excitation light.
